(19) United States
(12) Patent Application Publication
(10) Pub. No.: US 2015/0341124 A1
(43) Pub. Date: Nov. 26, 2015

(54) ASYNCHRONOUS RECEIVER-TRANSMITTER CIRCUIT AND WASHING MACHINE INCLUDING THE SAME

(71) Applicant: SAMSUNG ELECTRONICS CO., LTD., Suwon-si (KR)

(72) Inventors: Dong-Gyu LEE, Suwon-si (KR); Seung Hun LEE, Yongin-si (KR); Young Hwan HONG, Suwon-si (KR)

(73) Assignee: SAMSUNG ELECTRONICS CO., LTD., Suwon-si (KR)

(21) Appl. No.: 14/716,060

(22) Filed: May 19, 2015

(30) Foreign Application Priority Data
May 21, 2014 (KR) 10-2014-0060674

(51) Int. Cl. H04B 10/80; D06F 37/30; D06F 33/02

(52) U.S. Cl. CPC H04B 10/802; D06F 33/02; D06F 37/304

(57) ABSTRACT

An asynchronous receiver-transmitter circuit which compensates for an output signal so as to be the same as an input signal upon an asynchronous communication, and a washing machine including the same. The asynchronous receiver-transmitter circuit includes a photo-coupler turned on by an applied input signal to provide an output signal; and a compensation part configured to compensate for a time required while the output signal arrives at a high value to correspond to a time required while the output signal arrives at a low value.

### CROSS-REFERENCE TO RELATED APPLICATIONS

This application claims the benefit of Korean Patent Application No. 10-2014-0060674, filed on May 21, 2014 in the Korean Intellectual Property Office, the disclosure of which is incorporated herein by reference.

### BACKGROUND

1. Field

Embodiments of the present disclosure relate to an asynchronous receiver-transmitter circuit in which a signal applied to an input terminal is output through an output terminal without synchronization, and a washing machine including the same.

2. Description of the Related Art

A washing machine is an apparatus which washes clothes using power, and generally includes a water tub which stores wash water, a rotating tub which is rotatably installed in the water tub, a pulsator which is rotatably installed at a bottom of the rotating tub, and a motor and a clutch which rotate the rotating tub and the pulsator.

Also, the washing machine may include a control part which controls a driving operation of the rotating tub. The control part may be a micro-controller unit (MCU). In particular, the MCU may be subdivided according to its functions. For example, the MCU may be subdivided into a main MCU which controls sub-MCUs and thus controls overall operations of the washing machine, a driving MCU which controls a driving operation of a motor according to a controlling of the main MCU, and an input/output MCU which controls inputting from an outside and outputting to the outside.

The main MCU may receive and transmit data from/to one or more sub-MCUs. To this end, the control part of the washing machine may include a receiver-transmitter circuit which connects the main MCU with the sub-MCU.

### SUMMARY

Therefore, it is an aspect of the present disclosure to provide an asynchronous receiver-transmitter circuit which compensates for an output signal to be the same as an input signal upon an asynchronous communication, and a washing machine including the same.

Additional aspects of the disclosure will be set forth in part in the description which follows and, in part, will be apparent from the description, or may be learned by practice of the disclosure.

In accordance with one aspect of the present disclosure, an asynchronous receiver-transmitter circuit includes a photo-coupler turned on by an applied input signal to provide an output signal; and a compensation part configured to compensate for a time required while the output signal arrives at a high value to correspond to a time required while the output signal arrives at a low value.

The compensation part may include a first compensation part configured to delay a turning-on operation of the photo-coupler so as to correspond to a time required while the photo-coupler is turned off.

The first compensation part may delay the turning-on operation of the photo-coupler so that a time required while the photo-coupler is turned off and a time required while the photo-coupler is turned on coincide with each other.

The first compensation part may include a first capacitor charged by an input voltage of the input signal and thus to delay introducing the input signal to the photo-coupler.

The first compensation part may further include a first resistor connected in series with the first capacitor and thus determine an intensity of an input current of the input signal.

The first compensation part may delay the turning-on operation of the photo-coupler according to a delay time determined by a capacitance of the first capacitor and a resistance of the first resistor.

The first compensation part may further include a second resistor connected in parallel with the first capacitor so as to discharge the charged first capacitor.

The first compensation part may further include a first transistor turned on to transmit the input signal to the photo-coupler, when the first capacitor is charged by a predetermined voltage or more.

The first capacitor and the first transistor of the first compensation part may be connected with one of a plurality of terminals of an input terminal of the photo-coupler.

The first compensation part may further include a third resistor connected with another one of the plurality of terminals of the input terminal of the photo-coupler so as to determine an intensity of an input current of the input signal.

The compensation part may include a second compensation part configured to delay the output signal and thus to compensate for the time required while the output signal arrives at the high value.

The second compensation part may include a second capacitor charged by an output voltage of the output signal and thus to delay the output signal.

The second compensation part may further include a second transistor turned on to provide the delayed output signal to an outside, when the second capacitor is charged by a predetermined voltage.

The second capacitor and the second transistor of the second compensation part may be connected with one of a plurality of terminals of an output terminal of the photo-coupler.

The second compensation part may further include a fourth resistor connected in series with the second capacitor, and may compensate for a time required while the output signal arrives at the high value according to a delay time determined by a capacitance of the second capacitor and a resistance of the fourth resistor.

The second compensation part may further include one or more fifth resistors connected with the second capacitor to determine an intensity of an output current of the output signal.

The second compensation part may further include a sixth resistor connected in parallel with the second capacitor to discharge the charged second capacitor.

In accordance with another aspect of the present disclosure, a washing machine includes a rotating tub; a motor configured to transmit a rotating force to the rotating tub; and a control unit including a main control part configured to generate a control signal for controlling the motor, and a driving control part configured to control a driving operation of the motor based on the control signal, wherein the control unit further includes an asynchronous receiver-transmitter circuit including a photo-coupler configured to receive a first control signal generated from the main control part and to provide a second control signal corresponding to the first control signal to the driving control part, and a compensation part configured to compensate for a time required while the second control signal arrives at a high value to correspond to a time required while the second control signal arrives at a low value.

The compensation part may include a first compensation part configured to delay a turning-on operation of the photo-coupler so as to correspond to a time required while the photo-coupler is turned off.

The first compensation part may delay the turning-on operation of the photo-coupler so that a time required while the photo-coupler is turned off and a time required while the photo-coupler is turned on coincide with each other.

The first compensation part may include a first capacitor charged by an input voltage according to the first control signal and thus to delay introducing the first control signal to the photo-coupler.

The first compensation part may further include a first resistor connected in series with the first capacitor and thus to determine an intensity of an input current according to the first control signal.

The first compensation part may delay the turning-on operation of the photo-coupler according to a delay time determined by a capacitance of the first capacitor and a resistance of the first resistor.

The first compensation part may further include a second resistor connected in parallel with the first capacitor so as to discharge the charged first capacitor.

The first compensation part may further include a first transistor turned on to transmit the first control signal to the photo-coupler, when the first capacitor is charged by a predetermined voltage or more.

The first capacitor and the first transistor of the first compensation part may be connected with one of a plurality of terminals of an input terminal of the photo-coupler.

The first compensation part may further include a third resistor connected with another one of the plurality of terminals of the input terminal of the photo-coupler so as to determine an intensity of an input current according to the first control signal.

The compensation part may include a second compensation part configured to delay the second control signal and thus to compensate for the time required while the second control signal arrives at the high value.

The second compensation part may include a second capacitor charged by an output voltage according to the second control signal and thus to delay the second control signal.

The second compensation part may further include a second transistor turned on to provide the delayed second control signal to the driving control part, when the second capacitor is charged by a predetermined voltage.

The second capacitor and the second transistor of the second compensation part may be connected with one of a plurality of terminals of an output terminal of the photo-coupler.

The second compensation part may further include a fourth resistor connected in series with the second capacitor, and may compensate for a time required while the second control signal arrives at the high value according to a delay time determined by a capacitance of the second capacitor and a resistance of the fourth resistor.

The second compensation part may further include one or more fifth resistors connected with the second capacitor to determine an intensity of an output current according to the second control signal.

The second compensation part may further include a sixth resistor connected in parallel with the second capacitor to discharge the charged second capacitor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view of a washing machine in accordance with one embodiment;

FIG. 2 is a control block diagram of the washing machine in accordance with one embodiment;

FIG. 3 is a view illustrating a photo-coupler in accordance with one embodiment;

FIG. 4, parts (a) and (b), are graphs illustrating an input signal and an output signal of the photo-coupler;

FIG. 5, parts (a) and (b), are graphs illustrating a signal distortion phenomenon according to a difference between a turn-on delay time and a turn-off delay time of the photo-coupler;

FIG. 6 is a circuit diagram including an example of a first compensation part in accordance with one embodiment of an asynchronous receiver-transmitter circuit;

FIG. 7 is a circuit diagram including another example of the first compensation part in accordance with one embodiment of the asynchronous receiver-transmitter circuit;

FIG. 8 is a circuit diagram including still another example of the first compensation part in accordance with one embodiment of the asynchronous receiver-transmitter circuit;

FIG. 9 is a circuit diagram including an example of a second compensation part in accordance with another embodiment of the asynchronous receiver-transmitter circuit;

FIG. 10 is a circuit diagram including another example of the second compensation part in accordance with another embodiment of the asynchronous receiver-transmitter circuit;

FIGS. 11 to 16 are circuit diagrams including various examples of the first and second compensation parts in accordance with still another embodiment of the asynchronous receiver-transmitter circuit; and

FIG. 17, parts (a) and (b), are graphs illustrating a compensated result of the signal distortion phenomenon according to the difference between the turn-on delay time and the turn-off delay time of the photo-coupler.

### DETAILED DESCRIPTION

Hereinafter, an asynchronous receiver-transmitter circuit and a washing machine including the same will be described in detail with reference to the accompanying drawings.

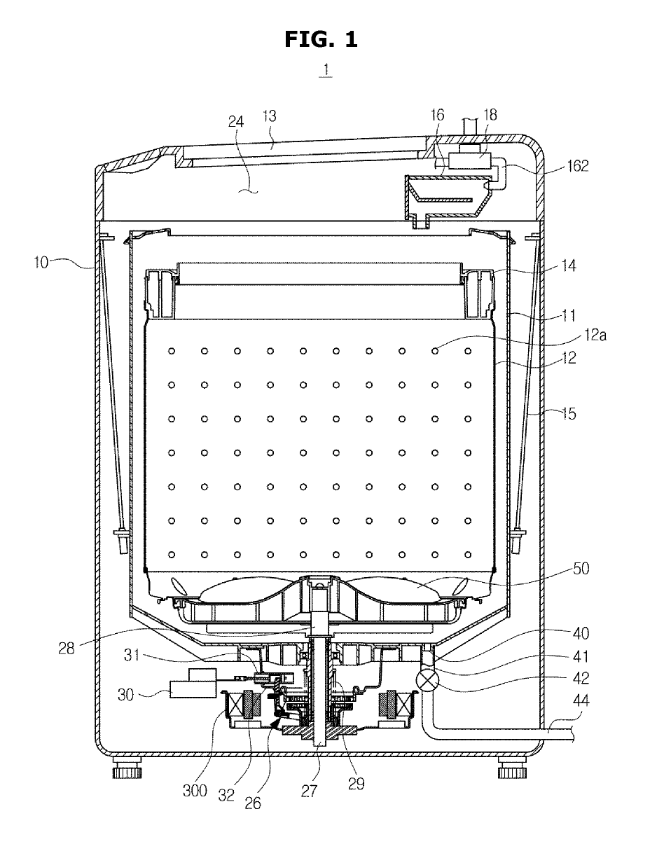

FIG. 1 is a cross-sectional view of a washing machine in accordance with one embodiment. Hereinafter, an exterior and a general operation of the washing machine will be described with reference to FIG. 1.

As illustrated in FIG. 1, the washing machine 1 includes a cabinet 10 which forms an exterior, a fixed tub 11 which is disposed in the cabinet 10 to store wash water, a rotating tub 12 which is rotatably disposed in the fixed tub 11, and a pulsator 50 which is disposed in the rotating tub 12 to generate a water stream.

An opening 24 is formed at an upper portion of the cabinet 10 so that laundry is put into the rotating tub 12. The opening 24 may be opened and closed by a door 13 installed at the upper portion of the cabinet 10. The fixed tub 11 may be supported to the cabinet 10 through a suspension device 15.

A water supply pipe 162 which supplies wash water to the fixed tub 11 is installed above the fixed tub 11. One side of the water supply pipe 162 is connected with an external water source, and the other side thereof is connected with a detergent supply unit 16. Water supplied through the water supply pipe 162 passes through the detergent supply unit 16, and thus is supplied into the fixed tub 11 together with a detergent. A water supply valve 18 is installed at the water supply pipe 162 to control water supply.

The rotating tub 12 is provided in a cylindrical shape of which an upper portion is opened, and a plurality of spin-drying holes 12a are formed at a side surface of the rotating tub 12. A balancer 14 may be installed at an upper portion of the rotating tub 12 so that the rotating tub 12 is stably rotated at a high speed.

A motor 300 which generates a driving force for rotating the rotating tub 12 and the pulsator 50, and a power switching unit 26 which simultaneously or selectively transmits the driving force generated from the motor 300 to the rotating tub 12 and the pulsator 50 are installed under the fixed tub 11.

A hollow spin-drying shaft 29 may be coupled to the rotating tub 12, and a washing shaft 27 installed in a hollow portion of the spin-drying shaft 29 may be coupled to the pulsator 50 via a washing shaft coupling part 28. The motor 300 may simultaneously or selectively transmit the driving force to the rotating tub 12 and the pulsator 50 according to an up and down movement of the power switching unit 26.

The power switching unit 26 may include an actuator 30 which generates a driving force for switching power supply, a rod part 31 which is linearly moved according to an operation of the actuator 30, and a clutch part 32 which is connected with the rod part 31 to be rotated according to an operation of the rod part 31.

A drain hole 40 is formed at a bottom of the fixed tub 11 to discharge the stored wash water, and a first drain pipe 41 is connected to the drain hole 40. A drain valve 42 which controls drainage may be installed at the first drain pipe 41. An outlet port of the drain valve 42 may be connected with a second drain pipe 44 which discharges the wash water to an outside.

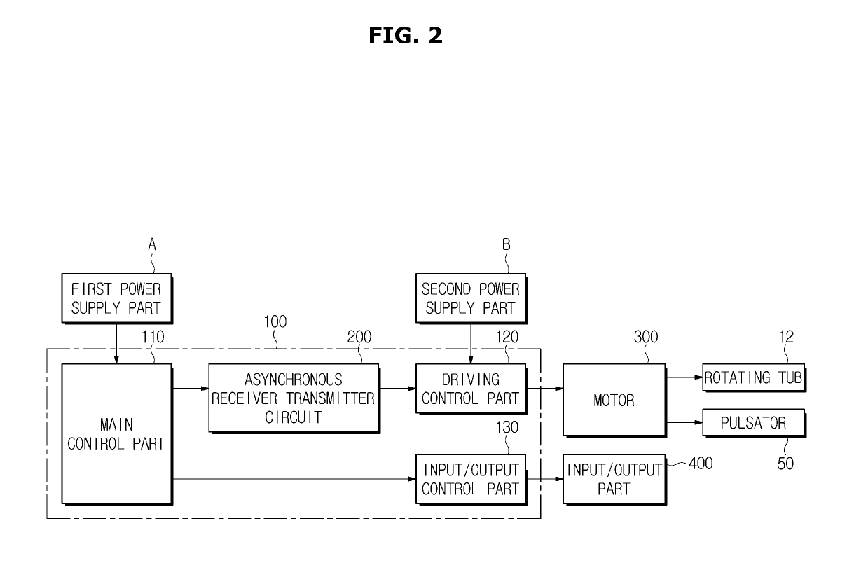

FIG. 2 is a control block diagram of the washing machine in accordance with one embodiment.

The washing machine in accordance with one embodiment may include an input/output part 400 which receives a control input for controlling the washing machine from a user and outputs a result thereof, a control unit 100 which generates a control signal according to the user's control input, the motor 300 which is driven based on the control signal, and the rotating tub 12 and the pulsator 50 which receive a rotating force from the driven motor 300 to be rotated.

The input/output part 400 may include an input part which receives the control input from the user, and an output part which outputs the result according to the control input. For example, when a start input of a washing stroke is input through the input part, an event which informs a start of the washing stroke may be output from the output part.

The input part and the output part may be realized by one structure such as a touchscreen, or may be separately provided.

Since the motor 300, the rotating tub 12 and the pulsator 50 are the same as those described in FIG. 1, the detailed description thereof will be omitted. Hereinafter, a specific structure of the control unit 100 will be described.

The control unit 100 may include a main control part 110 which controls an entire operation of the washing machine, an input/output control part 130 which controls the input or the output of the input/output part 400, and a driving control part 120 which controls a driving operation of the motor 300. The main control part 110, the input/output control part 130 and the driving control part 120 may be realized by a micro-controller unit (MCU) on each printed circuit board.

The main control part 110 may be configured to transmit and receive data to/from the input/output control part 130 and the driving control part 120, and thus to control the entire operation of the washing machine. That is, a receiver-transmitter circuit for transmitting and receiving the data may be provided between the main control part 110 and the input/output control part 130 and between the main control part 110 and the driving control part 120.

At this time, the receiver-transmitter circuit between the main control part 110 and the driving control part 120 may perform an insulation function. Since the driving control part 120 drives the motor 300, it is necessary to supply relatively greater power from a second power supply part B. On the other hand, since the main control part 110 simply generates the control signal to control the driving control part 120 or the input/output control part 130, power smaller than that supplied to the driving control part 120 may be provided from a first power supply part A. As described above, since there is a difference between the power supplied to the main control part 110 and the power supplied to the driving control part 120, the receiver-transmitter circuit which is provided for communication between the main control part 110 and the driving control part 120 needs to perform the insulation function.

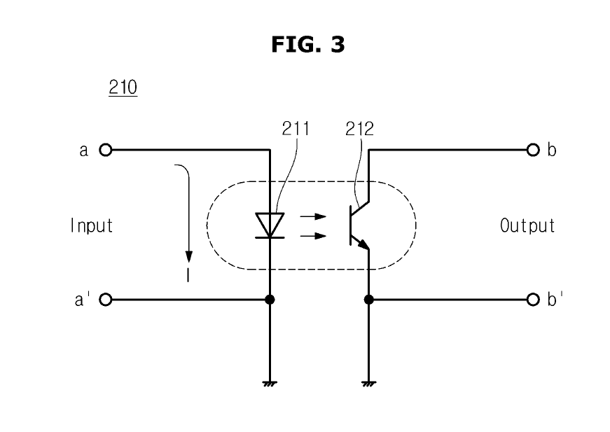

To perform the insulation function, the receiver-transmitter circuit may include a photo-coupler 210. Hereinafter, an operation of the photo-coupler 210 will be described with reference to FIGS. 3, 4 and 5.

FIG. 3 is a view illustrating the photo-coupler in accordance with one embodiment.

The photo-coupler 210 may be turned on by an applied input signal, and may provide an output signal.

Referring to FIG. 3, the photo-coupler 210 may include a light emitting part 211 which is provided at an input terminal to emit light when an electric signal is provided, and a light receiving part 212 which receives the light emitted from the light emitting part 211 and is provided at an output terminal to be turned on when an amount of the received light is more than a predetermined value.

The light emitting part 211 may be configured with a light emitting diode (LED) or a laser diode to emit the light when an input current of the applied input signal is provided. Also, the light receiving part 212 may be configured with a photo-diode or a photo-transistor to be turned on and to output the output signal when the amount of the received light arrives at the predetermined value or more.

Since the light emitting part 211 transmits a signal to the light receiving part 212 through a medium of the light, the input terminal and the output terminal of the photo-coupler 210 may be electrically insulated.

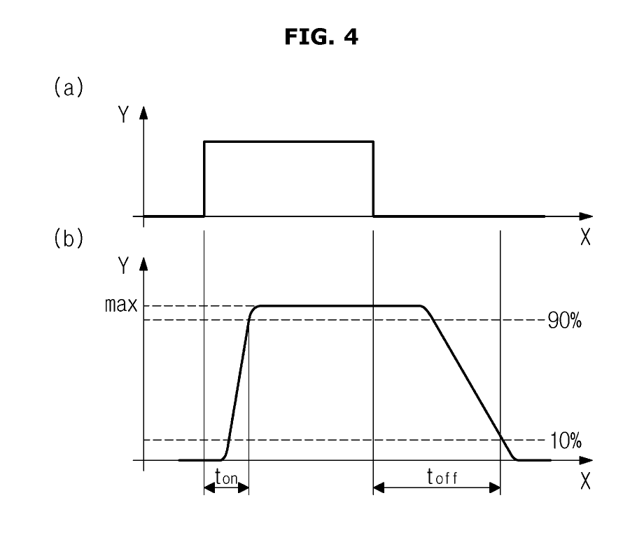

FIG. 4, parts (a) and (b), are graphs illustrating the input signal and the output signal of the photo-coupler. FIG. 4, part (a), is a graph illustrating an intensity of the input signal applied to the input terminal, and FIG. 4, part (b), is a graph illustrating an intensity of the output signal applied to the output terminal. In FIG. 4, parts (a) and (b), an x axis means a time, and a y axis means the intensity of the signal.

As illustrated in FIG. 4, part (a), a square wave as the input signal may be applied to the input terminal. The output signal corresponding to the applied input signal may be output from the output terminal, and the output signal may have a shape illustrated in FIG. 4, part (b).

Referring to FIG. 4, parts (a) and (b), there may be a little difference between the input signal and the output signal. The difference is caused by a turn-on or turn-off delay time of the photo-coupler 210.

Here, the turn-on delay time of the photo-coupler 210 may mean a period of time tₒₙ from a time when a positive edge of the input signal is generated to a time when the output signal arrives at a high value (e.g., 90% or more of an maximum intensity). Also, the turn-off delay time of the photo-coupler 210 may mean a period of time t_{off} from a time when a falling edge of the input signal is generated to a time when the output signal arrives at a low value (e.g., 10% or less of an maximum intensity).

In general, the time t_{off} is greater than the time tₒₙ.

At this time, when the turn-on delay time tₒₙ and the turn-off delay time t_{off} are different from each other, a receiver connected to the output terminal of the photo-coupler 210 may receive a signal distorted from a signal transmitted from a transmitter connected to the input terminal of the photo-coupler 210.

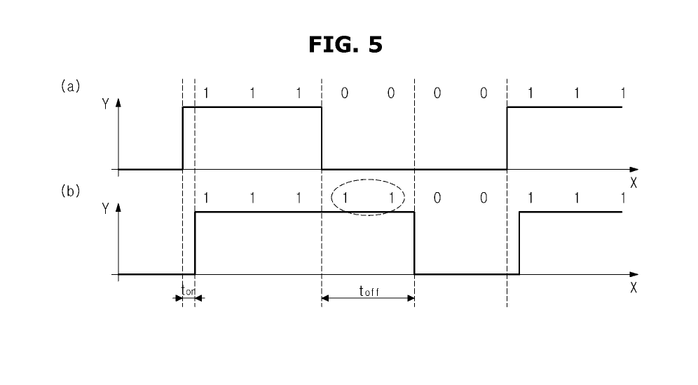

FIG. 5, parts (a) and (b), are graphs illustrating a signal distortion phenomenon according to a difference between the turn-on delay time and the turn-off delay time of the photo-coupler. FIG. 5, part (a), shows the signal transmitted from the transmitter connected to the input terminal of the photo-coupler 210, and FIG. 5, part (b), shows the signal received from the receiver connected to the output terminal of the photo-coupler 210.

In FIG. 5, parts (a) and (b), an x axis means a time, and a y axis means the intensity of the signal. It will be described on an assumption that a case in which the signal has the high value is “1”, and a case in which the signal has the low value is “0”.

The turn-on delay time may distort the signal so that “1” is erroneously recognized as “0”, and the turn-off delay time may distort the signal so that “0” is erroneously recognized as “1”. As a result, the signal received from the receiver may be different from the signal transmitted from the transmitter.

In comparison with FIG. 5, parts (a) and (b), the receiver may receive the distorted signal for the turn-off delay time, in which “0” is erroneously recognized as “1”. On the other hand, since the turn-on delay time is shorter than the turn-off delay time, a distortion of the signal may not occur. As a result, when the transmitter transmits a signal of “1110000111”, the receiver may receive a signal of “1111100111”.

Therefore, to prevent the distortion of the signal, it is necessary to compensate for the turn-on delay time and the turn-off delay time.

To this end, an asynchronous receiver-transmitter circuit 200 may include the photo-coupler 210 which is turned on by the applied input signal and provides the output signal, and a compensation part 220 which compensates for a time required while the output signal arrives at the high value so as to correspond to a time required while the output signal arrives at the low value.

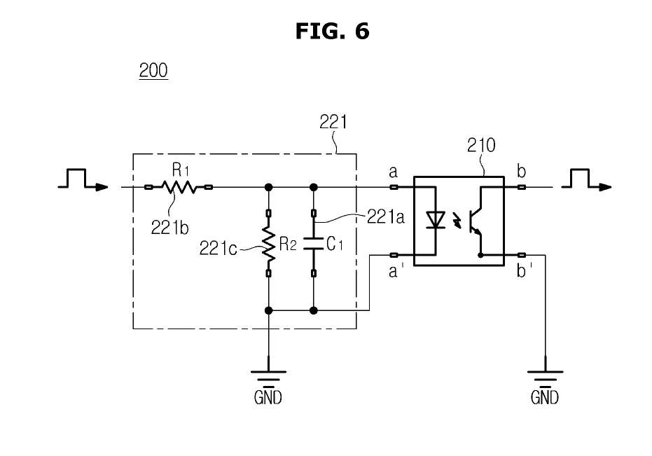

Hereinafter, the asynchronous receiver-transmitter circuit 200 which compensates for the turn-on delay time and the turn-off delay time so as to coincide with each other will be described with reference to FIGS. 6 to 16.

FIG. 6 is a circuit diagram including an example of a first compensation part in accordance with one embodiment of an asynchronous receiver-transmitter circuit.

As described above, the asynchronous receiver-transmitter circuit 200 may include the photo-coupler 210 and the compensation part 220. At this time, the compensation part 220 may include a first compensation part 221 which delays a turning-on operation of the photo-coupler 210 so as to correspond to a time required while the photo-coupler 210 is turned off. Specifically, the first compensation part 221 may delay the turning-on operation of the photo-coupler 210 so that the time required while the photo-coupler 210 is turned off coincides with a time required while the photo-coupler 210 is turned on.

To this end, the first compensation part 221 in accordance with one embodiment may include a first capacitor 221a which charges an input voltage of the input signal so as to delay introducing the input signal to the photo-coupler 210, and a first resistor 221b which is connected in series with the first capacitor 221a.

The first capacitor 221a and the resistor 221b may be provided at the input terminal of the photo-coupler 210. As a result, the input signal may be charged in the first capacitor 221a before being applied to the photo-coupler 210. When a charging operation of the first capacitor 221a is completed, the input signal is applied to the photo-coupler 210, and thus a time required while the photo-coupler 210 is turned on may be delayed.

At this time, the turn-on delay time of the photo-coupler 210, which is delayed by the first compensation part 221, may be determined by a capacitance C₁ of the first capacitor 221a and a resistance R₁ of the first resistor 221b. Therefore, the capacitance C₁ of the first capacitor 221a and the resistance R₁ of the first resistor 221b may be determined so as to correspond to a time intended to delay the input signal, and then the first compensation part 221 may be designed.

First, the resistance R₁ of the first resistor 221b may be obtained by the following Equation 1.

$${R}_{1} = \frac{{V}_{i}}{{I}_{on}} \qquad [ Equation 1 ]$$

Here, Vᵢ may be the input voltage of the input signal, and Iₒₙ may be a current required to turn on the photo-coupler 210. Since the resistance R₁ of the first resistor 221b may determine an intensity of the input current of the input signal, the resistance R₁ may be determined so that the input current is Iₒₙ.

The turn-on delay time tₒₙ and the turn-off delay time t_{off} of the photo-coupler 210 may be confirmed to determine the capacitance C₁ of the first capacitor 221a. The turn-on delay time tₒₙ and the turn-off delay time t_{off} may be determined in advance when the photo-coupler 210 is manufactured.

Then, a difference between turn-on delay time tₒₙ and the turn-off delay time t_{off} may be calculated. When the turn-on delay time tₒₙ and the turn-off delay time t_{off} are the same as each other, the distortion of the signal does not occur, and thus the difference between turn-on delay time tₒₙ and the turn-off delay time t_{off} may be a delay time t_{d} required in the input signal.

When the delay time t_{d} required in the input signal is determined, the capacitance C₁ of the first capacitor 221a may be obtained by the following Equation 2.

$${C}_{1} = \frac{{t}_{d}}{{R}_{1} \times ln ( \frac{{V}_{i}}{{V}_{i} - {V}_{o n}} )} \qquad [ Equation 2 ]$$

Here, t_{d} may be the delay time required in the input signal, and R₁ may be the resistance of the first resistor 221b. Also, Vᵢ may be the input voltage of the input signal, and Vₒₙ may be a voltage required to turn on the photo-coupler 210.

When the capacitance C₁ of the first capacitor 221a and the resistance R₁ of the first resistor 221b are determined through Equations 1 and 2, the first compensation part 221 may be realized based on determined values of the capacitance C₁ and the resistance R₁. Thus, the turn-on delay time of the photo-coupler 210 may coincide with the turn-off delay time thereof.

Also, the first compensation part 221 may further include a second resistor 221c which discharges the charged first capacitor 221a. To this end, the second resistor 220c may be connected in parallel with the first capacitor 221a.

A resistance R₂ of the second resistor 221c may be determined so that the first capacitor 221a is discharged within one pulse of the input signal. This is because, when the first capacitor 221a is not discharged within one pulse of the input signal, the turn-on delay time by the first compensation part 221 does not occur.

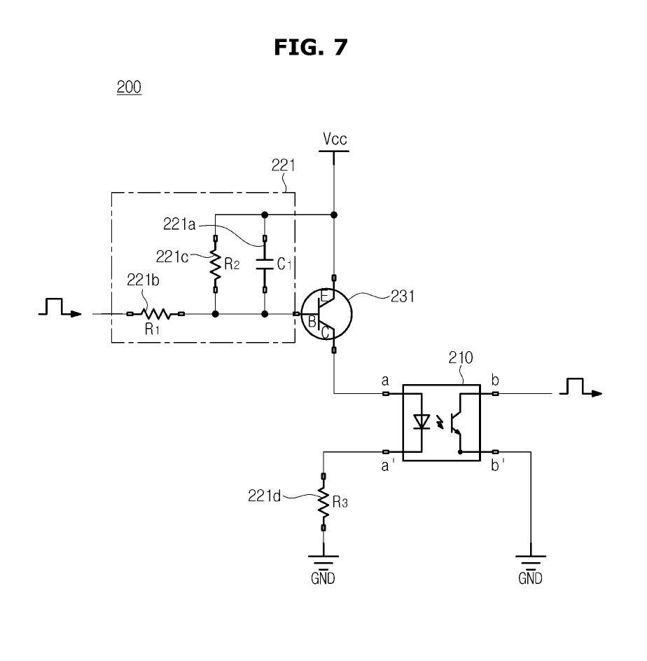

FIG. 7 is a circuit diagram including another example of the first compensation part in accordance with one embodiment of the asynchronous receiver-transmitter circuit. Like the embodiment of FIG. 6, the asynchronous receiver-transmitter circuit of FIG. 7 includes the photo-coupler 210 and the first compensation part 221.

The first compensation part 221 in accordance with another embodiment may include the first capacitor 221a, the first resistor 221b, the second resistor 221c, and a first transistor 231 which is turned on to transmit the input signal to the photo-coupler 210, when the first capacitor 221a is charged by a predetermined voltage.

The first capacitor 221a, the first resistor 221b and the second resistor 221c may be provided at the first compensation part 221 so as to control a voltage V_{BE} between a base and an emitter of the first transistor 231. Since a voltage charged in the first capacitor 221a is V_{BE}, the turn-on delay time of the first transistor 231 may be determined according to the voltage charged in the first capacitor 221a.

Specifically, when the first transistor 231 is turned on at V_{BE=V}ₜₒₙ, the capacitance C₁ of the first capacitor 221a and the resistance R₁ of the first resistor 221b may satisfy the following Equation 3.

$${C}_{1} = \frac{{t}_{d}}{{R}_{1} \times ln ( \frac{{V}_{i}}{{V}_{i} - {V}_{to n}} )} \qquad [ Equation 3 ]$$

Here, t_{d} may be the delay time required in the input signal, and R₁ may be the resistance of the first resistor 221b. Also, Vᵢ may be the input voltage of the input signal, and Vₜₒₙ may be a voltage required to turn on the first transistor 231.

In Equation 3, since the C₁ and R₁ are unknown variable values, all of C₁ and R₁ values which satisfy Equation 3 may be used. Therefore, a degree of design freedom may be increased.

At this time, the first compensation part 221 may include a third resistor 221d which determines an intensity of the input current of the input signal.

FIG. 7 illustrates a case in which the first capacitor 221a, the first resistor 221b, the second resistor 221c and the first transistor 231 are connected to an A terminal of the input terminal of the photo-coupler 210. Here, the A terminal may be a terminal through which the input signal is introduced into the photo-coupler 210.

On the other hand, it may be confirmed that the third resistor 221d is connected to an A′ terminal. Here, the A′ terminal may be a terminal through which the input signal is output from the photo-coupler 210.

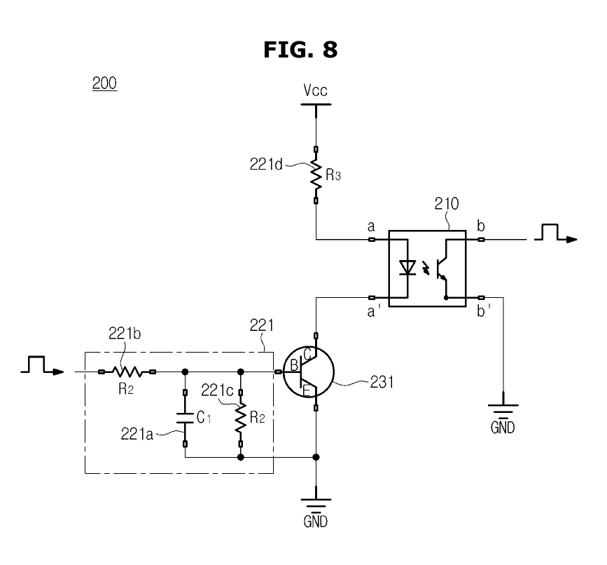

FIG. 8 is a circuit diagram including still another example of the first compensation part in accordance with one embodiment of the asynchronous receiver-transmitter circuit. Like the embodiment of FIG. 7, the asynchronous receiver-transmitter circuit of FIG. 8 includes the photo-coupler 210 and the first compensation part 221.

Unlike the embodiment of FIG. 7, FIG. 8 illustrates a case in which the first capacitor 221a, the first resistor 221b, the second resistor 221c and the first transistor 231 are connected to the A′ terminal of the input terminal of the photo-coupler 210. However, the third resistor 221d may be connected with the A terminal.

As shown in FIG. 8, one of the terminals of the input terminal of the photo-coupler 210 may be connected with the first capacitor 221a, the first resistor 221b, the second resistor 221c and the first transistor 231, and another one thereof may be connected with the third resistor 221d.

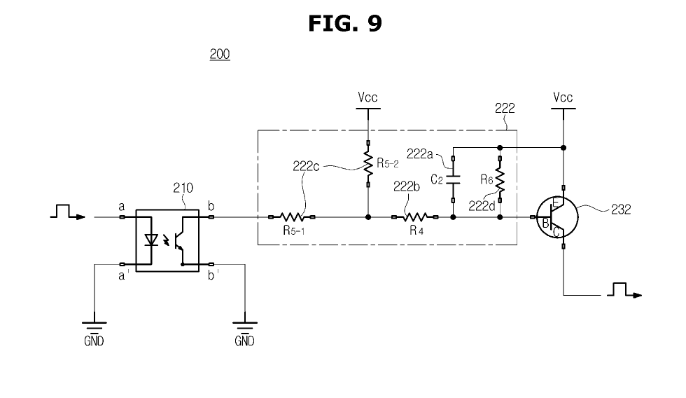

Until now, one embodiment of the asynchronous receiver-transmitter circuit 200 including the first compensation part 221 which compensates for the turn-on delay time of the photo-coupler 210 so as to coincide with the turn-off delay time has been described with reference to FIGS. 6 to 8. Hereinafter, another embodiment of the asynchronous receiver-transmitter circuit 200 including a second compensation part 222 will be described with reference to FIGS. 9 to 11.

FIG. 9 is a circuit diagram including an example of a second compensation part in accordance with another embodiment of the asynchronous receiver-transmitter circuit.

As described above, the asynchronous receiver-transmitter circuit 200 may include the photo-coupler 210 and the compensation part 220. At this time, the compensation part 220 may include the second compensation part which delays the output signal and compensates for the time required while the output signal arrives at the high value. That is, unlike the first compensation part 221 which compensates for the input signal before being applied to the photo-coupler 210 and provides a compensated output signal, the second compensation part 222 may directly compensate for the output signal output from the photo-coupler 210, and thus may prevent the distortion of the signal.

To this end, the second compensation part 222 in accordance with one embodiment may include a second capacitor 222a which charges the output voltage of the output signal so as to delay the output signal, a fourth resistor 222b which is connected in series with the second capacitor 222a, and a second transistor 232 which is turned on to provide the delayed output signal to an outside, when the second capacitor 222a is charged by a predetermined voltage.

The second capacitor 222a and the fourth resistor 222b may be provided at the second compensation part 222 so as to control a voltage V_{BE} between a base and an emitter of the second transistor 232. Since a voltage charged in the second capacitor 222a is V_{BE}, the turn-on delay time of the second transistor 232 may be determined according to the voltage charged in the second capacitor 222a.

Specifically, when the second transistor 232 is turned on at V_{BE=V}ₜₒₙ, a capacitance C₂ of the second capacitor 222a and a resistance R₄ of the fourth resistor 222b may satisfy the following Equation 4.

$${C}_{2} = \frac{{t}_{d}}{{R}_{4} \times ln ( \frac{{V}_{o}}{{V}_{o} - {V}_{to n}} )} \qquad [ Equation 4 ]$$

Here, t_{d} may be the delay time required in the output signal, and R₄ may be the resistance of the fourth resistor 222b. Also, Vₒ may be the output voltage of the output signal, and Vₜₒₙ may be a voltage required to turn on the second transistor 232.

The t_{d} may be obtained by calculating the difference between the turn-off delay time t_{off} of the photo-coupler 210 and the turn-on delay time tₒₙ thereof.

In Equation 4, since the C₂ and R₄ are unknown variable values, all of C₂ and R₄ values which satisfy Equation 4 may be used. Therefore, a degree of design freedom may be increased.

When the second compensation part 222 is provided at the output terminal of the photo-coupler 210 based on this method, the output signal output from the photo-coupler 210 may be delayed by the second capacitor 222a, the fourth resistor 222b and the second transistor 232, and thus the distortion of the signal may be compensated.

Also, the second compensation part 222 may further include one or more fifth resistors 222c which are connected with the second capacitor 222a to determine an intensity of an output current of the output signal. In FIG. 9, R₅₋₁ and R₅₋₂ are used as the fifth resistors 222c.

In addition, the second compensation part 222 may further include a sixth resistor 222d which is connected in parallel with the second capacitor 222a so as to discharge the second capacitor 222a. A resistance R₆ of the sixth resistor 222d may be determined so that the second capacitor 222a is discharged within one pulse of the output signal.

FIG. 9 illustrates a case in which the second capacitor 222a, the fourth resistor 222b, the fifth resistor 222c, the sixth resistor 222d and the second transistor 232 are connected to a B terminal of the output terminal of the photo-coupler 210. Also, it may be confirmed that a B′ terminal is connected to the ground.

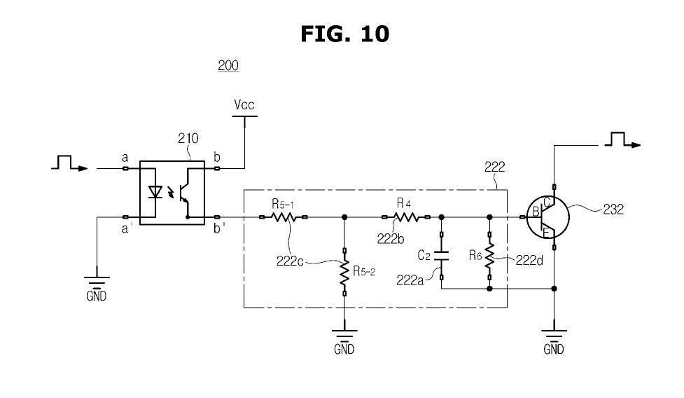

FIG. 10 is a circuit diagram including another example of the second compensation part in accordance with another embodiment of the asynchronous receiver-transmitter circuit. Like the embodiment of FIG. 9, the asynchronous receiver-transmitter circuit of FIG. 10 includes the photo-coupler 210 and the second compensation part 222.

Unlike the embodiment of FIG. 9, FIG.10 illustrates a case in which the second capacitor 222a, the fourth resistor 222b, the fifth resistor 222c, the sixth resistor 222d and the second transistor 232 are connected to the B′ terminal of the output terminal of the photo-coupler 210.

As shown in FIG. 10, one of terminals of the output terminal of the photo-coupler 210 may be connected with the second capacitor 222a, the fourth resistor 222b, the fifth resistor 222c, the sixth resistor 222d and the second transistor 232.

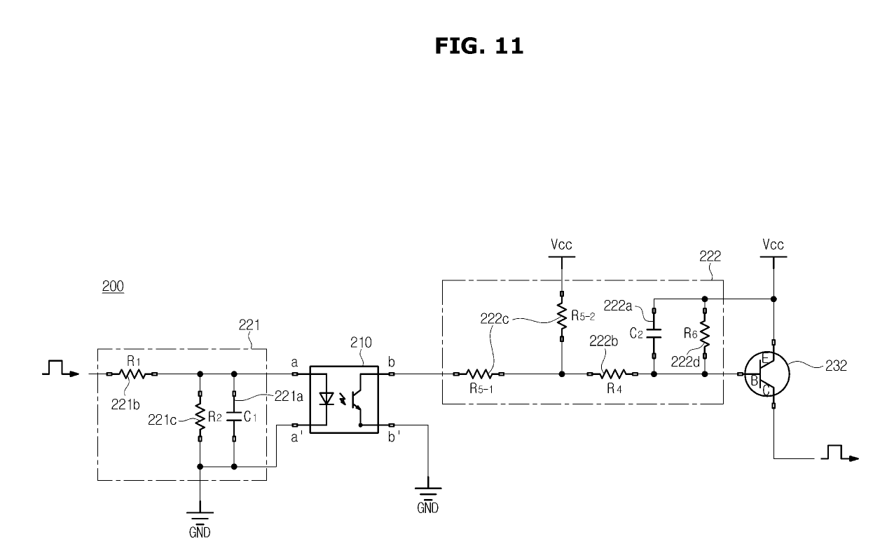

Until now, one embodiment of the asynchronous receiver-transmitter circuit 200 including the second compensation part 222 which delays the output signal and thus compensates for the time required while the output signal arrives at the high value has been described with reference to FIGS. 9 and 10. Hereinafter, still another embodiment of the asynchronous receiver-transmitter circuit 200 including the first and second compensation parts 221 and 222 will be described with reference to FIGS. 11 to 16.

FIGS. 11 to 16 are circuit diagrams including various examples of the first and second compensation parts in accordance with still another embodiment of the asynchronous receiver-transmitter circuit.

The compensation part 220 of the asynchronous receiver-transmitter circuit 200 may include the first compensation part 221 which delays the turning-on operation of the photo-coupler 210 so as to correspond to the time required while the photo-coupler 210 is turned off, and the second compensation part 222 which delays the output signal and thus compensates for the time required while the output signal arrives at the high value.

When the compensation part 220 includes all of the first and second compensation parts 221 and 222, the time required while the output signal arrives at the high value may be more accurately compensated.

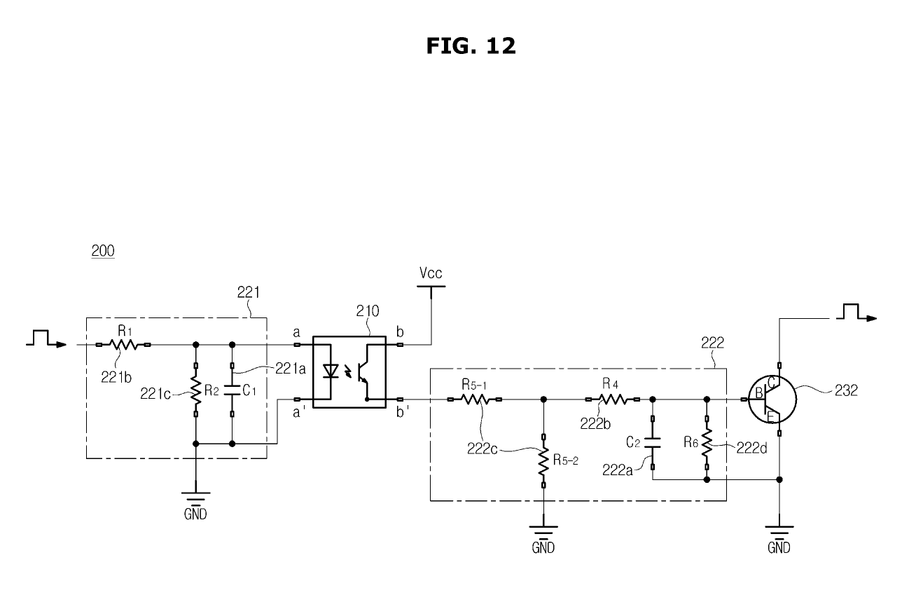

FIGS. 11 and 12 illustrate a case in which the first compensation part 221 in accordance with the embodiment of FIG. 6 is provided at the input terminal of the photo-coupler 210. At this time, the second compensation part 222 may be connected to the output terminal of the photo-coupler 210.

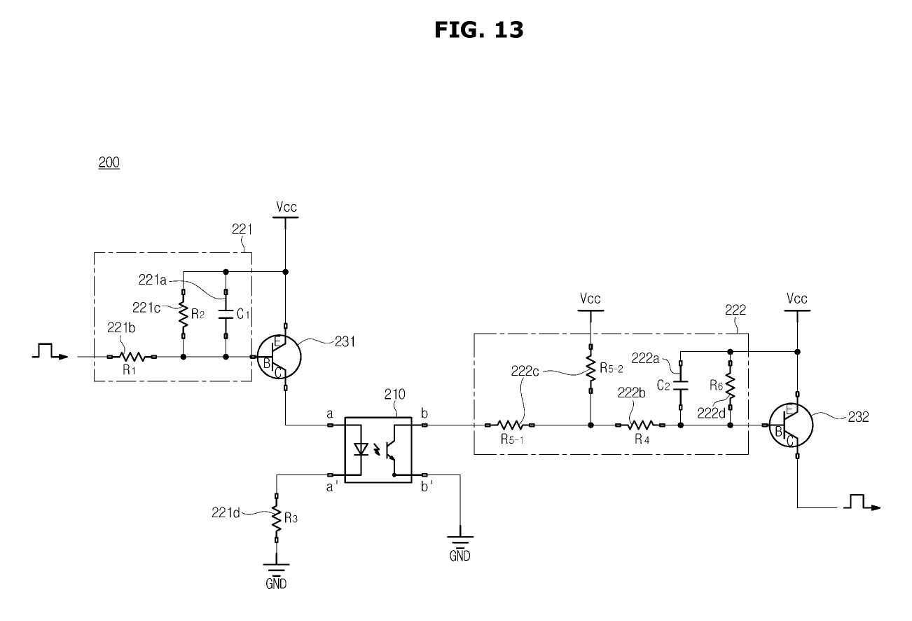

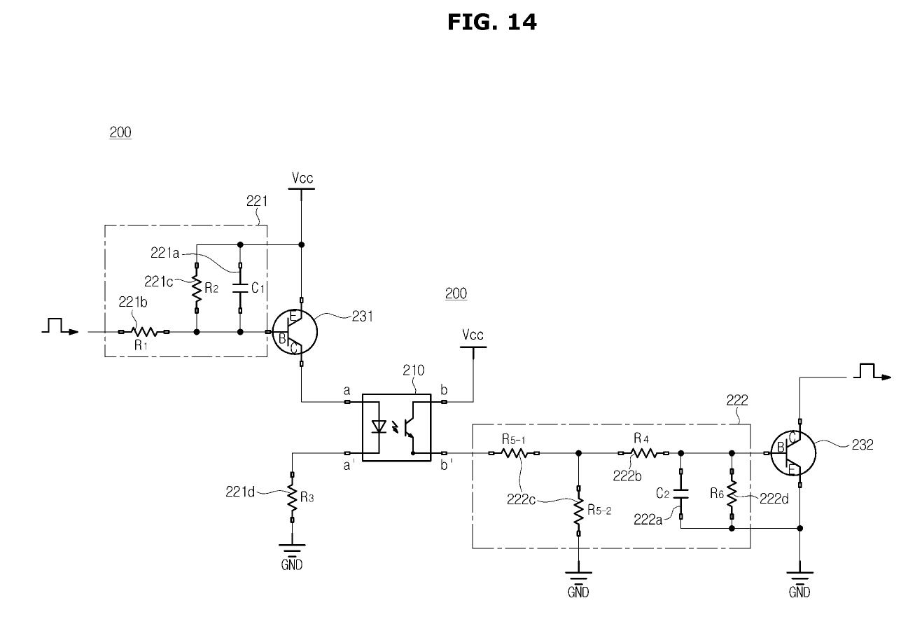

FIGS. 13 and 14 illustrate a case in which the first compensation part 221 in accordance with the embodiment of FIG. 7 is provided at the input terminal of the photo-coupler 210. At this time, the second compensation part 222 may be connected to the output terminal of the photo-coupler 210.

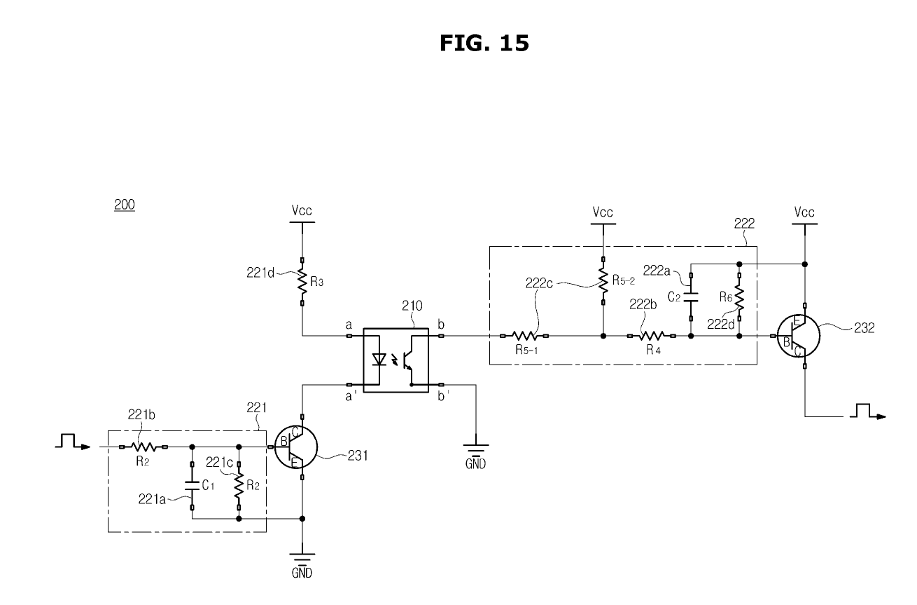

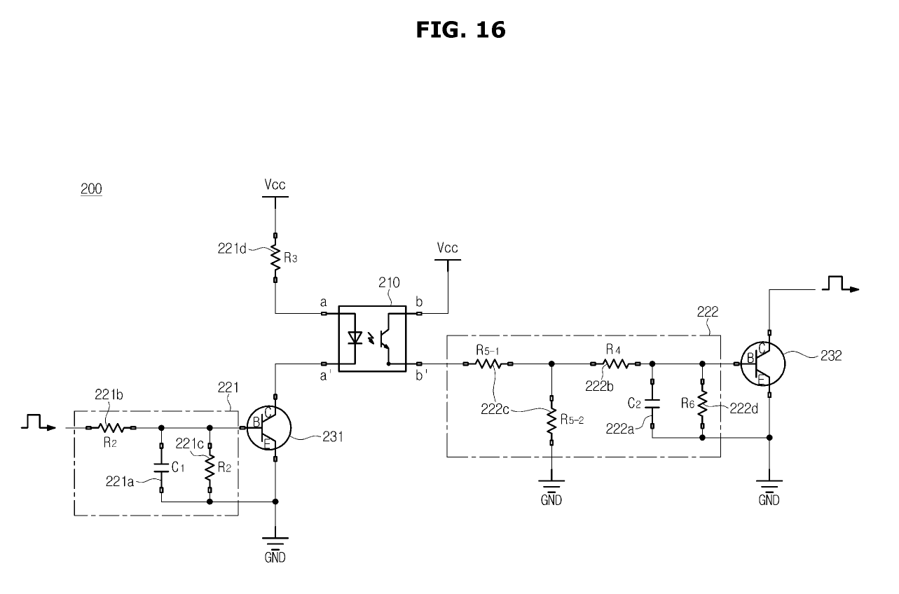

FIGS. 15 and 16 illustrate a case in which the first compensation part 221 in accordance with the embodiment of FIG. 8 is provided at the input terminal of the photo-coupler 210. At this time, the second compensation part 222 may be connected to the output terminal of the photo-coupler 210.

The asynchronous receiver-transmitter circuit 200 described with reference to FIGS. 6 to 16 may compensate for the signal so that the signal transmitted from the transmitter is transmitted to the receiver without the distortion of the signal.

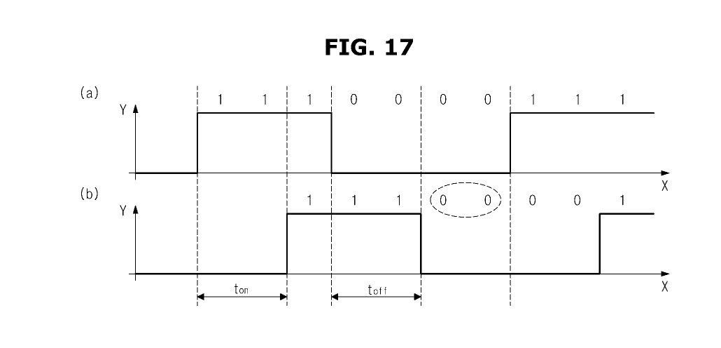

FIG. 17, parts (a) and (b), are graphs illustrating a compensated result of the signal distortion phenomenon according to the difference between the turn-on delay time and the turn-off delay time of the photo-coupler. FIG. 17, part (a), may be the signal transmitted from the transmitter connected with the input terminal of the photo-coupler 210, and FIG. 17, part (b), may be the signal received by the receiver connected with the output terminal of the photo-coupler 210.

In FIG. 17, parts (a) and (b), an x axis means a time, and a y axis means the intensity of the signal. FIG. 17, parts (a) and (b), will be described on an assumption that a case in which the signal has the high value is “1”, and a case in which the signal has the low value is “0”.

As confirmed in FIG. 5, part (b), when the turn-off delay time t_{off} of the photo-coupler 210 is longer than the turn-on delay time tₒₙ thereof, the signal may be distorted. Therefore, the compensation part 220 of the asynchronous receiver-transmitter circuit 200 may perform the compensation so that the turn-off delay time t_{off} and the turn-on delay time tₒₙ are the same as each other. As a result, the signal which is the same as the transmitted signal may be received by the receiver, as illustrated in FIG. 17, part (b).

Referring to FIG. 2 again, the asynchronous receiver-transmitter circuit 200 may be connected with the main control part 110 as the transmitter for transmitting the signal, and may be connected with the driving control part 120 as the receiver for receiving the signal.

The main control part 110 may generate a first control signal and then may provide the first control signal to the asynchronous receiver-transmitter circuit 200. The photo-coupler 210 of the asynchronous receiver-transmitter circuit 200 may receive the first control signal as the input signal, and then may output a second control signal as the output signal corresponding to the first control signal. At this time, the compensation part 220 of the asynchronous receiver-transmitter circuit 200 may compensate for a time required while the second control signal arrives at the high value so as to correspond to a time required while the second control signal arrives at the low value.

As a result, the main control part 110 and the driving control part 120 of the washing machine may transmit and receive data without the distortion of the signal.

According to one aspect of the asynchronous receiver-transmitter circuit and the washing machine including the same, the output signal is compensated to be the same as the input signal upon the asynchronous communication, and thus the data can be accurately received and transmitted.

According to another aspect of the asynchronous receiver-transmitter circuit and the washing machine including the same, the output signal can be compensated using the capacitor and the resistor, and thus a high performance communication environment can be provided at a low cost.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. An asynchronous receiver-transmitter circuit comprising:
a photo-coupler turned on by an applied input signal to provide an output signal; and
a compensation part configured to compensate for a time required while the output signal arrives at a high value to correspond to a time required while the output signal arrives at a low value.

2. The asynchronous receiver-transmitter circuit according to claim 1, wherein the compensation part comprises a first compensation part configured to delay a turning-on operation of the photo-coupler so as to correspond to a time required while the photo-coupler is turned off.

3. The asynchronous receiver-transmitter circuit according to claim 2, wherein the first compensation part delays the turning-on operation of the photo-coupler so that a time required while the photo-coupler is turned off and a time required while the photo-coupler is turned on coincide with each other.

4. The asynchronous receiver-transmitter circuit according to claim 2, wherein the first compensation part comprises a first capacitor charged by an input voltage of the input signal and thus is configured to delay introducing the input signal to the photo-coupler.

5. The asynchronous receiver-transmitter circuit according to claim 4, wherein the first compensation part further comprises a first resistor connected in series with the first capacitor and thus is configured to determine an intensity of an input current of the input signal.

6. The asynchronous receiver-transmitter circuit according to claim 5, wherein the first compensation part delays the turning-on operation of the photo-coupler according to a delay time determined by a capacitance of the first capacitor and a resistance of the first resistor.

7. The asynchronous receiver-transmitter circuit according to claim 4, wherein the first compensation part further comprises a second resistor connected in parallel with the first capacitor so as to discharge the charged first capacitor.

8. The asynchronous receiver-transmitter circuit according to claim 4, wherein the first compensation part further comprises a first transistor turned on to transmit the input signal to the photo-coupler, when the first capacitor is charged by a predetermined voltage or more.

9. The asynchronous receiver-transmitter circuit according to claim 8, wherein the first capacitor and the first transistor of the first compensation part are connected with one of a plurality of terminals of an input terminal of the photo-coupler.

10. The asynchronous receiver-transmitter circuit according to claim 9, wherein the first compensation part further comprises a third resistor connected with another one of the plurality of terminals of the input terminal of the photo-coupler so as to determine an intensity of an input current of the input signal.

11. The asynchronous receiver-transmitter circuit according to claim 1, wherein the compensation part comprises a second compensation part configured to delay the output signal and thus is configured to compensate for the time required while the output signal arrives at the high value.

12. The asynchronous receiver-transmitter circuit according to claim 11, wherein the second compensation part comprises a second capacitor charged by an output voltage of the output signal and thus is configured to delay the output signal.

13. The asynchronous receiver-transmitter circuit according to claim 12, wherein the second compensation part further comprises a second transistor turned on to provide the delayed output signal to an outside, when the second capacitor is charged by a predetermined voltage.

14. The asynchronous receiver-transmitter circuit according to claim 13, wherein the second capacitor and the second transistor of the second compensation part are connected with one of a plurality of terminals of an output terminal of the photo-coupler.

15. The asynchronous receiver-transmitter circuit according to claim 12, wherein the second compensation part further comprises a fourth resistor connected in series with the second capacitor, and compensates for a time required while the output signal arrives at the high value according to a delay time determined by a capacitance of the second capacitor and a resistance of the fourth resistor.

16. The asynchronous receiver-transmitter circuit according to claim 12, wherein the second compensation part further comprises one or more fifth resistors connected with the second capacitor to determine an intensity of an output current of the output signal.

17. The asynchronous receiver-transmitter circuit according to claim 12, wherein the second compensation part further comprises a sixth resistor connected in parallel with the second capacitor to discharge the charged second capacitor.

18. A washing machine comprising:
a rotating tub;
a motor configured to transmit a rotating force to the rotating tub; and
a control unit comprising a main control part configured to generate a control signal for controlling the motor, and a driving control part configured to control a driving operation of the motor based on the control signal,
wherein the control unit further comprises
an asynchronous receiver-transmitter circuit comprising a photo-coupler configured to receive a first control signal generated from the main control part and to provide a second control signal corresponding to the first control signal to the driving control part, and
a compensation part configured to compensate for a time required while the second control signal arrives at a high value to correspond to a time required while the second control signal arrives at a low value.

19. The washing machine according to claim 18, wherein the compensation part comprises a first compensation part configured to delay a turning-on operation of the photo-coupler so as to correspond to a time required while the photo-coupler is turned off.

20. The washing machine according to claim 19, wherein the first compensation part delays the turning-on operation of the photo-coupler so that a time required while the photo-coupler is turned off and a time required while the photo-coupler is turned on coincide with each other.

21. The washing machine according to claim 19, wherein the first compensation part comprises a first capacitor charged by an input voltage according to the first control signal and thus is configured to delay introducing the first control signal to the photo-coupler.

22. The washing machine according to claim 21, wherein the first compensation part further comprises a first resistor connected in series with the first capacitor and thus is configured to determine an intensity of an input current according to the first control signal.

23. The washing machine according to claim 22, wherein the first compensation part delays the turning-on operation of the photo-coupler according to a delay time determined by a capacitance of the first capacitor and a resistance of the first resistor.

24. The washing machine according to claim 21, wherein the first compensation part further comprises a second resistor connected in parallel with the first capacitor so as to discharge the charged first capacitor.

25. The washing machine according to claim 21, wherein the first compensation part further comprises a first transistor turned on to transmit the first control signal to the photo-coupler, when the first capacitor is charged by a predetermined voltage or more.

26. The washing machine according to claim 25, wherein the first capacitor and the first transistor of the first compensation part are connected with one of a plurality of terminals of an input terminal of the photo-coupler.

27. The washing machine according to claim 26, wherein the first compensation part further comprises a third resistor connected with another one of the plurality of terminals of the input terminal of the photo-coupler so as to determine an intensity of an input current according to the first control signal.

28. The washing machine according to claim 18, wherein the compensation part comprises a second compensation part configured to delay the second control signal and thus to compensate for the time required while the second control signal arrives at the high value.

29. The washing machine according to claim 28, wherein the second compensation part comprises a second capacitor charged by an output voltage according to the second control signal and thus is configured to delay the second control signal.

30. The washing machine according to claim 29, wherein the second compensation part further comprises a second transistor turned on to provide the delayed second control signal to the driving control part, when the second capacitor is charged by a predetermined voltage.

31. The washing machine according to claim 30, wherein the second capacitor and the second transistor of the second compensation part are connected with one of a plurality of terminals of an output terminal of the photo-coupler.

32. The washing machine according to claim 29, wherein the second compensation part further comprises a fourth resistor connected in series with the second capacitor, and compensates for a time required while the second control signal arrives at the high value according to a delay time determined by a capacitance of the second capacitor and a resistance of the fourth resistor.

33. The washing machine according to claim 29, wherein the second compensation part further comprises one or more fifth resistors connected with the second capacitor to determine an intensity of an output current according to the second control signal.

34. The washing machine according to claim 29, wherein the second compensation part further comprises a sixth resistor connected in parallel with the second capacitor to discharge the charged second capacitor.
